(19) United States
(12) Patent Application Publication
(10) Pub. No.: US 2026/0214576 A1
(43) Pub. Date: Jul. 23, 2026

(54) METHOD FOR SMALL DATA TRANSMISSION IN POWER SAVING STATE AND RELATED DEVICES

(71) Applicant: PURPLEVINE INNOVATION COMPANY LIMITED, Hongkong (CN)

(72) Inventor: Chiu-Wen CHEN, Hongkong (CN)

(73) Assignee: PURPLEVINE INNOVATION COMPANY LIMITED, Hongkong (CN)

(21) Appl. No.: 19/141,301

(22) PCT Filed: Dec. 19, 2023
(86) PCT No.: PCT/CN2023/139950

§ 371 Date: Jun. 19, 2025

Related U.S. Application Data
(60) Provisional application No. 63/476,058, filed on Dec. 19, 2022.

(30) Foreign Application Priority Data
Mar. 6, 2023 (WO) PCT/CN2023/079799

(51) Int. Cl. H04W 52/02; H04W 68/02

(52) U.S. Cl. CPC H04W 52/0229; H04W 68/02

(57) ABSTRACT

A method for small data transmission (SDT) in a power saving state and related devices are provided. The method, performed by a user equipment (UE), includes being configured with radio bearers for small data transmission (SDT); monitoring a mobile terminated (MT) indication in a paging occasion in the power saving state; upon reception of the MT indication via radio access network (RAN) paging, transmitting a connection resume request with a resume cause indicating mobile terminated small data transmission (MT-SDT) to request data reception in the power saving state, and in response to the request of data reception being accepted, performing the MT-SDT to receive data based on the configured radio bearers without state transition. With this method, support with MT traffic transmission in the power saving state is realized

### TECHNICAL FIELD

The present disclosure relates to the field of wireless communications, and more particularly, to a method for small data transmission (SDT) in a power saving state and related devices.

### BACKGROUND ART

Communication systems and networks have developed towards being a broadband and mobile system. In cellular wireless communication systems developed by the Third Generation Partnership Project (3GPP), user equipment (UE) is connected by a wireless link to a radio access network (RAN). The RAN includes a set of base stations (BSs) which provide wireless links to the UEs located in cells covered by the base station, and an interface to a core network (CN) which provides overall network control. As will be appreciated, the RAN and CN each conduct respective functions in relation to the overall network. The 3GPP has developed the so-called Long Term Evolution (LTE) system, namely, an Evolved Universal Mobile Telecommunication System Territorial Radio Access Network (E-UTRAN), for a mobile access network where one or more macro-cells are supported by a base station known as an eNodeB or eNB (evolved NodeB) More recently, evolved from LTE, the so-called 5G or new radio (NR) systems where one or more cells are supported by a base station known as a gNB.

In LTE, the network may order the UE to get into an RRC_IDLE state if the UE has no activity for a while. This is done to reduce UE's power consumption. The UE needs to transit from the RRC IDLE state to an RRC CONNECTED state whenever the UE needs to perform some activity. Since small amounts of data have to be sent very frequently in current mobile communication applications, frequent Idle-Connected-Idle transitions increase network signaling load and latency. Therefore, 5G NR has defined a new state called RRC INACTIVE to reduce network signaling load and latency involved in transiting to RRC CONNECTED state, In NR, a UE is in RRC CONNECTED when an RRC connection has been established or in RRC INACTIVE when the RRC connection is suspended. If this is not the case, the UE is in RRC IDLE state, that is, no RRC connection is established. The RRC INACTIVE and RRC IDLE states may be referred to as a power saving state. More specifically, in RRC INACTIVE state, the UE Access Stratum (AS) context is stored at both UE and network sides so that the core network connection is maintained (i.e., the UE keeps in CM (abbreviated from Connection Management)-CONNECTED) and the radio access network (RAN) connection is released. The network can reach the inactive UE through RAN or CN Paging messages.

UE performs a random access (RA) procedure to get access to the network. The RA procedure can be a four-step (4-step) procedure or a two-step (2-step) procedure. Taking 4-step contention-based RA procedure for example, the UE transmits a PRACH preamble, also known as MSG1. After detecting the preamble, the gNB responds with a random-access response (RAR), also known as MSG2. The RAR includes an uplink grant for scheduling a PUSCH transmission from the UE known as MSG3. In response to the RAR, the UE transmits MSG3 including an ID for contention resolution. Upon receiving MSG3, the network transmits a contention resolution message, also known as MSG4, with the contention resolution ID. The UE receives MSG4, and if the UE finds its contention-resolution ID it sends an acknowledgement on a PUCCH, which completes the 4-step random access procedure. The 2-step RA procedure is to reduce latency and control signaling overhead by having a single round trip cycle between the UE and the base station. This is achieved by combining the preamble (MSG1) and the scheduled PUSCH transmission (MSG3) into a single message (MSGA) from the UE to the gNB, known as MSGA and by combining the random-access respond (MSG2) and the contention resolution message (MSG4) into a single message (MSGB) from the gNB to UE.

The next generation wireless communication network is expected to provide high speed, low latency and ultra-reliable communication capabilities and fulfill the requirements from different industries and end users. Until 3GPP Rel-16, data transmission is only supported in RRC_CONNECTED state. When a UE stays in RRC_INACTIVE and UL data arrives in TX buffer, the UE has to resume the connection (i.e., move to RRC CONNECTED state) for data transmission. Connection setup and subsequently release to RRC INACTIVE state happens for each data transmission. However, for small and infrequent data packets, this results in unnecessary power consumption and signaling overhead. Until 3GPP Rel-17, mobile-oriented (MO) small data transmission (SDT) via random access channel (RACH) or configured grant (CG) in power saving state (e.g., RRC_INACTIVE state) is supported for NR system 3GPP Rel-17 allows mobile-oriented small packet transmission in power saving state. However, for small DL-oriented packets or mobile-terminated (MT) traffic, the legacy mechanism is not applicable since the data radio bearer (DRB) is suspended to or is not resumed to support data/signaling exchange during power saving state for MT traffic. The UE should transit to the connected state for receiving DL small data packets. It may result in frequent UE state transition, enormous power consumption and massive signaling overhead. Therefore, there is a need to design the operations for MT traffic transmission in power saving state.

Furthermore, if some DL resources are configured to support those Mobile Terminated small data transmissions (MT-SDT) in power saving state, whether the MT-SDT resources can be used in the change of serving cells should be considered. Moreover, there is a need to design validity conditions for the MT-SDT resources in power saving state.

### SUMMARY

An object of the present disclosure is to propose a method for small data transmission (SDT) in a power saving state and related devices (such as a user equipment (UE) and/or a base station (BS)), which can solve issues in the prior art, realize mobile terminated (MT) traffic transmission in the power saving state, improve resource efficiency, improve power consumption and signaling overhead, and/or provide a good communication performance.

In a first aspect of the present disclosure, provided is a method for small data transmission (SDT) in a power saving state, performed by a user equipment (UE) in a network, the method including: being configured with radio bearers for small data transmission (SDT), monitoring a mobile terminated (MT) indication in a paging occasion in the power saving state; upon reception of the MT indication via radio access network (RAN) paging, transmitting a connection resume request with a resume cause indicating mobile terminated small data transmission (MT-SDT) to request data reception in the power saving state; and in response to the request of data reception being accepted, performing the MT-SDT to receive data based on the configured radio bearers without state transition.

In a second aspect of the present disclosure, provided is a method for small data transmission (SDT) in a power saving state, performed by a user equipment (UE) in a network, the method including: being configured with radio bearers for small data transmission (SDT); transmitting a connection resume request with a resume cause indicating mobile terminated small data transmission (MT-SDT) to request data reception in the power saving state; and in response to the request of data reception being accepted, upon reception of a mobile terminated (MT) indication, performing the MT-SDT to receive data based on the configured radio bearers without state transition.

In a third aspect of the present disclosure, provided is a method for small data transmission (SDT) in a power saving state, performed by a user equipment (UE) in a network, the method including: being configured with radio bearers for small data transmission (SDT); transmitting a connection resume request with a resume cause indicating mobile terminated small data transmission (MT-SDT) to initiate RAN notification area (RNA) update in the power saving state, in response to the RNA update, upon reception of a mobile terminated (MT) indication, performing the MT-SDT to receive data based on the configured radio bearers without state transition

In a fourth aspect of the present disclosure, provided is a method for small data transmission (SDT) performed by a base station (BS) in a network, the method including: configuring a user equipment (UE) with radio bearers for small data transmission (SDT); transmitting a mobile terminated (MT) indication in a paging occasion for the UE in a power saving state; expecting to receive a connection resume request with a resume cause indicating mobile terminated small data transmission (MT-SDT) to request data reception in the power saving state if the UE receives the MT indication via radio access network (RAN) paging; and transmitting the MT-SDT based on the configured radio bearers if the request of data reception is accepted, for the UE to receive data without state transition.

In a fifth aspect of the present disclosure, provided is a method for small data transmission (SDT), performed by a base station (BS) in a network, the method including: configuring a user equipment (UB) with radio bearers for small data transmission (SDT); receiving a connection resume request with a resume cause indicating mobile terminated small data transmission (MT-SDT) to request data reception in a power saving state, and in response to the request of data reception being accepted, transmitting a mobile terminated (MT) indication to the UE and transmitting the MT-SDT based on the configured radio bearers for the UB to receive data without state transition.

In a sixth aspect of the present disclosure, provided is a method for small data transmission (SDT), performed by a base station (BS) in a network, the method including configuring a user equipment (UE) with radio bearers for small data transmission (SDT); receiving a connection resume request with a resume cause indicating mobile terminated small data transmission (MT-SDT) to initiate RAN notification area (RNA) update in a power saving state; in response to the RNA update, transmitting a mobile terminated (MT) indication to the UE and transmitting the MT-SDT based on the configured radio bearers for the UE to receive data without state transition.

In a seventh aspect of the present disclosure, a user equipment includes a memory and a processor coupled to the memory, the processor configured to call and run program instructions stored in a memory, to execute the method of any of the first aspect to the third aspect.

In an eighth aspect of the present disclosure, a base station includes a memory and a processor coupled to the memory, the processor configured to call and run program instructions stored in a memory, to execute the method of any of the fourth aspect to the sixth aspect.

In a ninth aspect of the present disclosure, a non-transitory machine-readable storage medium has stored thereon instructions that, when executed by a computer, cause the computer to perform any of the above methods.

In a tenth aspect of the present disclosure, a chip includes a processor, configured to call and run a computer program stored in a memory, to cause a device in which the chip is installed to execute any of the above methods In an eleventh aspect of the present disclosure, a computer readable storage medium, in which a computer program is stored, causes a computer to execute any of the above methods.

In a twelfth aspect of the present disclosure, a computer program product includes a computer program, and the computer program causes a computer to execute any of the above methods.

In a thirteenth aspect of the present disclosure, a computer program causes a computer to execute any of the above methods.

### DESCRIPTION OF DRAWINGS

In order to more clearly illustrate the embodiments of the present disclosure or related art, the following figures will be described in the embodiments are briefly introduced. It is obvious that the drawings are merely some embodiments of the present disclosure, a person having ordinary skill in this field can obtain other figures according to these figures without paying the premise.

FIG. 1(a) is a schematic diagram illustrating a communication controlling system according to an embodiment of the present disclosure.

FIG. 1(b) is a block diagram of a user equipment and a base station of wireless communication in a communication controlling system according to an embodiment of the present disclosure.

FIG. 2 is a schematic diagram illustrating radio protocol architecture within gNB and UE for SDT.

FIG. 3 is a schematic diagram illustrating a gNB further including a centralized unit (CU) and a plurality of distributed unit (DUs).

FIG. 4 is a flowchart of a method for small data transmission in a power saving state according to another embodiment of the present disclosure.

FIG. 5 is a flowchart of a method for small data transmission in a power saving state according to yet another embodiment of the present disclosure.

FIG. 6 is a flowchart of MT-SDT according to a first embodiment of the present disclosure.

FIG. 7 is a flowchart of MT-SDT according to a second embodiment of the present disclosure.

FIG. 8 is a flowchart of MT-SDT according to a third embodiment of the present disclosure.

FIG. 9 is a flowchart of MT-SDT according to a fourth embodiment of the present disclosure.

FIG. 10 is a flowchart of MT-SDT according to a fifth embodiment of the present disclosure.

FIG. Il is a flowchart of MT-SDT according to a sixth embodiment of the present disclosure.

FIG. 12 is a flowchart of MT-SDT according to a seventh embodiment of the present disclosure.

FIG. 13 is a flowchart of MT-SDT according to an eighth embodiment of the present disclosure.

FIG. 14 is a flowchart of MT-SDT according to a ninth embodiment of the present disclosure.

FIG. 15 is a flowchart of MT-SDT according to a tenth embodiment of the present disclosure.

### DETAILED DESCRIPTION OF EMBODIMENTS

Embodiments of the disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

In this document, the term “/” should be interpreted to indicate “and/or.” A combination such as “at least one of A, B, or C,” “one or more of A, B, or C,” “at least one of A, B, and C,” “one or more of A, B, and C.” or “A, B, and/or C” may be A only, B only, C only, A and B, A and 30 C, B and C, or A and B and C, where any combination may contain one or more members of A, B, or C.

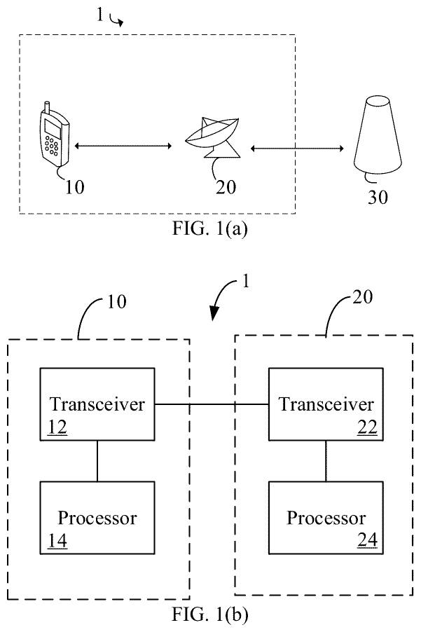

A schematic view and a functional block diagram of a communication controlling system 1 according to the present invention are shown in FIG. 1(a) and FIG. 1(b) respectively. The communication controlling system 1 includes a user equipment 10 and a base station 20. The user equipment 10 and the base station 20 may communicate with each other either wirelessly or in a wired way. The base station 20 and a next generation core network 30 may also communicate with each other either wirelessly or in a wired way. When the communication controlling system 1 complies with the New Radio (NR) standard of the 3rd Generation Partnership Project (3GPP), the next generation core network (SGCN) 30 is a backend serving network system and may include an Access and Mobility Management Function (AMF), User Plane Function (UPF), and a Session Management Function (SMF).

The user equipment 10 includes a transceiver 12 and a processor 14, which are electrically connected with each other. The base station 20 includes a transceiver 22 and a processor 24, which are electrically connected with each other. The transceiver 12 of the user equipment 10 is configured to transmit a signal to the base station 20 (and receive a signal from the base station 20) and the processor 24 of the base station 20 processes the signal, the transceiver 22 of the base station 20 is configured to transmit a signal to the user equipment 10 (and receive a signal from the user equipment 10) and the processor 14 of the user equipment 10 processes the signal. In this way, the user equipment 10 communicates with the base station 20 each other.

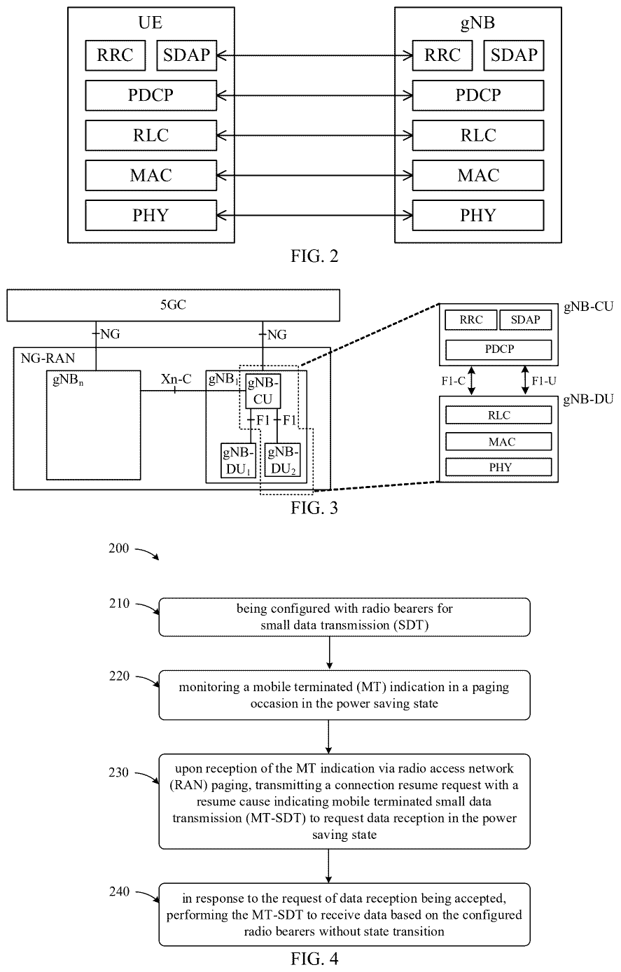

The radio protocol architecture within the base station (gNB) and UE for SDT is shown in FIG. 2, which includes Radio Resource Control (RRC), Service Data Adaptation Protocol (SDAP), Packet Data Convergence Protocol (PDCP), Radio Link Control (RLC), Medium Access Control (MAC). In FIG. 3, the new radio mobile communication system conforms to the specification of the next generation of mobile communication technology and includes a NG-RAN (the NO-RAN may be referred to as a gNB) and a NG-Core (the NG-Core is referred to as a next generation core network). A gNB includes a centralized unit (CU) and a plurality of distributed unit (DUs). An F1 interface is individually established between the CU and DUs, wherein the FI interface is a logic interface defined in the specification of the next generation of mobile communication technology. In this scenario, the protocol stack of CU includes an RRC layer, a SDAP layer, and a PDCP layer, while the protocol stack of DU includes an RLC layer, a MAC layer, and a PHY layer The F1 interface between the CU and DU is established between the PDCP layer and the RLC layer of the protocol stacks.

FIG. 4 illustrates a method 200 for small data transmission in a power saving state according to another embodiment of the present disclosure. In this method 200, MT-SDT is network-triggered. The network can initiate the MT-SDT by paging a user equipment (UE) in a paging occasion, The network-triggered MT-SDT may be referred to embodiments numbered from the first to the fifth as shown in FIGS. 6 to 10 in the following context. The method 200 is performed by a user equipment (UE) in a network. The method 200 may include the following steps.

In step 210, the UE is configured by a network node (e.g., a base station such as gNB) with radio bearers for small data transmission (SDT). The radio bearers may be configured in a SDT bearer configuration, which may be from an anchor base station which the UE anchors at or from a non-anchor base station which the UJE is to connect with. The associated bearer configuration may be configured by radio resource control (RRC) signaling (e.g., RRCReconfiguration, RRCRelease with SDT configuration). In an illustrated example, the SDT bearer configuration may be stored in UE context, and then the non-anchor base station may retrieve the UE context including the SDT bearer configuration from the anchor base station by using a retrieve UE context procedure The non-anchor base station may then configure the UE with the radio bearers for SDT based on the SDT bearer configuration of the retrieved UE context. The network can only trigger MT-SDT if downlink (DL) small data belongs to the SDT bearers.

In step 220, the UE monitors a mobile terminated (MT) indication in a paging occasion in the power saving state (e.g., RRC_INACTIVE). The base station may check its buffer, and when there are DL data for the UE and the DL data are applicable to be transmitted in the UE power saving state, the base station will transmit the MT indication to the UE. The MT indication is received via a paging message by radio access network (RAN) paging and may be received from an anchor base station which the UE anchors at or from a non-anchor base station which the UE is to connect with. While the UE is in the power saving state, the UE will monitor the MT indication in a paging occasion for receiving the DL small data. That is, the MT indication is used to indicate the UE that there are DL small data for the UE in the power saving state. The MT indication may include only one bit for indicating there are DL small data for the UE. In addition to the one bit the MT indication may include additional bits for other information. For example, the MT indication may be associated with resource allocation or scheduling information of the DL small data. In another aspect, resource allocation or scheduling information of the DL small data may be associated with resource allocation of the MT indication That is, resource allocation of the DL small data is related to resource allocation of the MT indication

In step 230, upon reception of the MT indication via the RAN paging, the UE transmits a connection resume request with a resume cause indicating mobile terminated small data transmission (MT-SDT) to request data reception in the power saving state. Even though the MT indication is transmitted, the base station may not know whether the UE receives the MT indication. The transmission of the DL small data may fail if the DL small data are transmitted right after the MT indication. In order to ensure reliability of data transmission, after receiving the MT indication, the UE notifies the base station that the UE is ready to receive the DL small data. This is done by the UE to transmit to the base station a connection resume request with a resume cause (e.g., RRCResumeRequest with resumeCause set to mtAccess or a new resume cause) indicating MT-SDT. If the base station receives such a connection resume request and the base station decides to accept this request, the base station transmits the DL small data in a MT-SDT procedure based on the configured radio bearers.

In step 240, in response to the request of data reception being accepted, the UE performs the MT-SDT to receive data based on the configured radio bearers without state transition. In this step, by the MT-SDT procedure, the UE can receive the DL small data in the power saving state (without any state transition) based on the radio bearers configured in step 210. The MT-SDT may be transmitted on MT-SDT resources following the transmission of MT-SDT indication. In an embodiment, allocation for the MT-SDT resources may be associated with a pre-determined configuration (e.g., paging occasion, DCI occasion, SPS occasion, CG occasion). In an illustrated example, the transmission of MT-SDT may follow the paging occasion based on a MT-SDT interval/offset. In another illustrated example, the transmission of MT-SDT may be scheduled via downlink control information (DCI) following the MT-SDT indication. In still another illustrated example, the MT-SDT may be performed on MT-SDT resources, which are semi-persistent scheduling (SPS) resources pre-configured by a RRC signaling, and semi-persistent scheduling for MT-SDT may be activated via the same paging message carrying the MT indication In yet another illustrated example, transmission of MT-SDT may be scheduled before a CG occasion based on a CG-SDT interval/offset. In addition, the MT-SDT may be transmitted on PDCCH or PDSCH on an associated bandwidth part (BWP) (e.g., initial BWP or non-initial BWP (i.e., active BWP or default BWP)). In addition to one-shot MT-SDT, subsequent downlink (DL) small data may be received by the UE based on the MT-SDT.

More specifically, in response to reception of the data via the MT-SDT, the UE may transmit to the base station a response on configured grant (CG)-SDT resources. The CG-SDT resources may be valid based on reference signal received power (RSRP)-based timing advance (TA) validation.

More specifically, the MT-SDT may be performed based on a random access (RA)-SDT, which is based on a random access procedure, with or without uplink (UL) small data. The uplink small data (if any) may be transmitted on MSGA or MSG3 of the RA-SDT, and the downlink small data may be transmitted on MSGB or MSG4 of the RA-SDT. The RA-SDT may be initiated by the UE upon reception of the MT-SDT indication.

More specifically, in response to the MT-SDT, the UE may select a specific preamble for the random access procedure from a preamble partitioning. The preamble partitioning may be defined on a feature or feature combination basis, and physical random access channel (PRACH) resource set including preambles and random access channel (RACH) occasion is associated with the feature or feature combination. In addition, the preamble partitioning may be associated with bandwidth part (BWP).

With the proposed method 200 illustrated above, the invention can realize support with mobile terminated (MT) small data transmission (SDT) in a new radio access system (e.g., NR) or next-generation communication, and the infrequent (e.g., periodic and/or non-periodic) small data can be exchanged when a UE is in the power saving state. In some scenarios, especially for the case where the UE receives RAN paging from a non-anchor base station, the infrequent small data can be received even when the UE moves out of configured RNA.

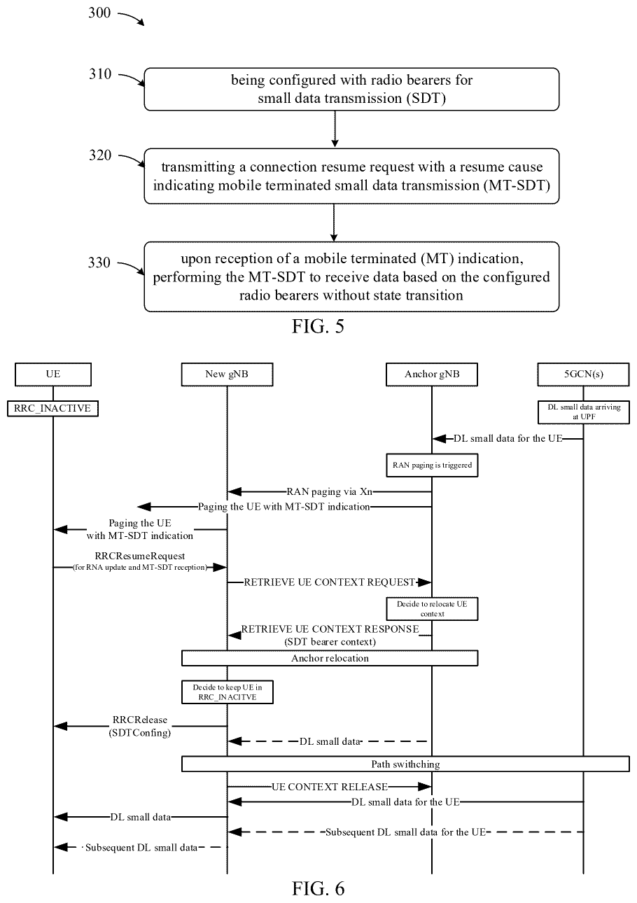

FIG. 5 illustrates a method 300 for small data transmission in a power saving state according to yet another embodiment of the present disclosure. In this method 300, MT-SDT is UE-triggered. The UE can request downlink data transmission via a MT-SDT procedure. The UE-triggered MT-SDT may be referred to embodiments numbered from the sixth to the tenth as shown in FIGS. 11 to 15 in the following context. The method 300 is performed by a user equipment (UE) in a network. The method 300 may include the following steps.

In step 310, the UE is configured by a network node (e.g., a base station such as gNB) with radio bearers for small data transmission (SDT). This step is similar to the afore-described step 210 and details on this step may be referred to step 210 mentioned above.

In step 320, the UE transmits a connection resume request with a resume cause indicating mobile terminated small data transmission (MT-SDT). This step is similar to the afore-described step 230 and details on this step may be referred to step 230 mentioned above. However, different from step 230, the MT-SDT is UE-initiated other than Network-initiated. In this step, the UE requests the MT-SDT by transmitting a connection resume request with a resume cause (e.g., RRCResumeRequest with resumeCause set to mtAccess or a new resume cause) indicating the MT-SDT. In this way, the base station knows the UE wants to receive DL small data in the power saving state. In some cases, if the base station receives the connection resume request with a resume case indicating the MT-SDT from the UE, the base station can treat it as a request to request data reception in the power saving state. In some other cases, if the network receives the connection resume request with a resume case indicating the MT-SDT from the UE, RAN notification area (RNA) update is initiated and transmission of the MT-SDT is performed by the network based on the updated RNA.

In step 330, upon reception of a mobile terminated (MT) indication, the UE performs the MT-SDT to receive data based on the configured radio bearers without state transition. This step is similar to the afore-described step 240 and details on this step may be referred to step 240 mentioned above. In some cases, this step is performed in response further to the request of data reception being accepted. In some other cases, this step is performed in response further to the RNA update.

With the proposed method 300 illustrated above, the invention can realize support with mobile terminated (MT) small data transmission (SDT) in a new radio access system (e.g., NR) or next-generation communication, and the infrequent (e.g., periodic and/or non-periodic) small data can be exchanged when a UE is in the power saving state. In some scenarios, especially for the case of RNA update, the infrequent small data can be received even when the UE moves out of configured RNA.

Further details of the invention are described as follows.

For a UE in RRC INACTIVE, the SDT bearer configuration should be handled when starting the SDT procedure even if the anchor relocation of the UJE context is required. The associated bearer configuration is configured by RRC signaling (e.g., RRCReconfiguration, RRCRelease with SDT configuration) and stored in UE context. Some MT-SDT resources (e.g., semi-persistent scheduling resource, dynamic scheduling resource) are also configured to support Mobile Terminated small data transmissions (MT-SDT). In some embodiments, the MT-SDT resources using semi-persistent scheduling is the scheme in which the PDSCH is pre-configured by RRC signaling (e.g., RRCRelease with SDT configuration). In some further embodiments, the MT-SDT resources using dynamic scheduling is the scheme in which every PDSCH is scheduled by downlink control information (DCD). The network can only trigger MT-SDT if the DL small data belongs to the SDT bearers. In some embodiments, if the UE connects with a new gNB other than the original serving gNB (i.e., anchor gNB), the new gNB may trigger the Retrieve UE Context procedure with a cause value of RAN notification area (RNA) update or Tracking area update (TAU). The decision whether to provide DE context (including SDT bearer context) for anchor relocation is made by the anchor gNB upon the reception of RETRIEVE UE CONTEXT REQUEST from the new gNB. When the new gNB receives RETRIEVE UE CONTEXT RESPONSE with SDT bearer context, it needs to configure the SDT bearer for the UE. It should be noted that the SDT bearer context may include the information about SDT data radio bearers, PDU sessions and QoS flows associated to the UB. The SDT bearer context contains the necessary information required to maintain SDT service toward the UE.

In case of DL small data arrival for the UE from core networks, based on the validity conditions for MT-SDT, the anchor gNB should transmit MT-SDT indication to involved UE in the cells corresponding to the RNA and may send RAN/CN paging to the UE(s). It should be noted that MT-SDT resources can be used only when at least one of the validity conditions for MT-SDT is met. RSRP threshold for SDT is included in SDT configuration. The network can configure the same or different RSRP threshold for MT and MO small data transmission in the power saving state. In addition, some examples of validity conditions for MT-SDT are shown as below, but the invention is not limited thereto:
DL small data payload is allowed for MT-SDT resources
QoS constraints is allowed for MT-SDT
SDT bearer configuration is done for the UE with/without anchor relocation
Periodic RNA Update timer is valid
RAN paging is successful

During MT-SDT, the UE should monitor a MT-SDT indication (at least one bit) in any PDCCH/paging occasion on the associated active BWP. In some embodiments, the anchor or non-anchor gNB may transmit MT-SDT indication via PDCCH or RRC signaling (e.g., paging, RRCRelease) to initiate MT-SDT. Upon the reception of MT indication, the UE transmits a connection resume request with a resume cause indicating mobile terminated small data transmission (MT-SDT) to request data reception. With some RN A update scenarios, the UE receives MT-SDT indication from non-anchor gNB. In response to the resume request with RNA update from the UE, the non-anchor gNB may transmit MT-SDT indication via PDCCH or RRC signaling (e.g., paging, RRCRelease). If there is an indication of the non-SDT DL data arrival during an SDT session, the UE should resume the connection and fallback to RRC CONNECTED state for the non-SDT data reception. If there is an MT-SDT indication to indicate DL small data arrival for the UE, the UE can perform a Mobile Terminated (MT) small data reception procedure disclosed as one of the following without state transition.
When the MT-SDT indication is present via DCI, a new DCI format with CRC scrambled by a Radio Network Temporary Identifier (e.g., Small Data Transmission-RNTI (SDT-RNTD), Temporary Cell-RNTI (TC-RNTD), Inactive-RNTI (I-RNTI), Paging-RNTI (P-RNTD), Cell-RNTI (C-RNTI), Configured Scheduling-RNTI (CS-RNTI), etc.) is used to indicate and schedule MT-SDT PDSCH resources for the UE(s). Then the UE monitors the PDCCH and PDSCH on the associated BWP for MT-SDT reception (including initial/subsequent MT-SDT, and HARQ retransmission.) in RRC INACTIVE state.
When the MT-SDT indication is per UE and explicitly included in a paging message from the anchor gNB, the MT-SDT should be transmitted on the MT-SDT resources following the transmission of MT-SDT indication from the network. The MT-SDT resource allocation may be associated with a pre-determined configuration (e.g., paging occasion, DCI occasion, SPS occasion, CG occasion.)

In some embodiments, the transmission of MT-SDT may be implicitly following paging occasion based on the MT-SDT interval/offset. The MT-SDT interval/offset can be configured within RRC signaling (e.g., RRCRelease with SDT configuration). The UE can receive the MT-SDT based on the paging message and MT-SDT interval/offset.

In some embodiments, the transmission of MT-SDT is scheduled via DCI following MT-SDT indication within the paging message. The UE monitors the PDCCH and PDSCH on the associated BWP for MT-SDT reception in RRC_INACTIVE state

In some embodiments, SPS for MT-SDT is also activated via the same paging message. The UE monitors the SPS resources on the associated BWP for MT-SDT reception in RRC INACTIVE state.

In some further embodiments, the transmission of MT-SDT may be scheduled before CG occasion based on the CO-SDT interval/offset The UE can receive the MT-SDT based on the paging message and CG-SDT interval/offset The UE can determine whether to perform CG-SDT for MT-SDT based on CG-SDT interval/offset.

When the MT-SDT indication is per UE and explicitly included in a paging or RRCRelease message from a new gNB other than the anchor gNB, it means RAN/CN paging is triggered and the SDT bearer configuration should be done between the UE and the new gNB after the RNA update or Tracking area update procedure with/without UE context relocation is performed. The UE receives an RRCRelease with suspend configuration (e.g., SDT configuration) from the new gNB and resumes the RRC connection if necessary, The new gNB triggers the upcoming MT-SDT when DL small data is received from core networks.

In some embodiments, the transmission of MT-SDT is supported over a network-triggered RACH procedure. The UE can receive the MT-SDT based on network-triggered RA-SDT with/without UL small data. Alternatively, the transmission of MT-SDT is supported by relocated UE context (including SDT bearer configuration). The UJE can receive the MT-SDT indication based on the received suspend configuration (including SDT configuration) and/or SPS activation from the new gNB when anchor relocation is performed. Then MT-SDT is received by the UE on the SPS occasion(s).

In response to the MT-SDT indication, UE may initiate a connection resume procedure (i.e., RRCResumeRequest with resumeCause set to mtAccess or a new resume cause) and follows the behaviors of MO-SDT. With the new resume cause, the network can differentiate the connection resume procedure for MT-SDT. The MO-SDT (i.e., RA-SDT and CG-SDT) is a procedure to enable UL small data transmission in the RRC INACTIVE state. For RA-SDT, the UE transmits UL small data using separated radio resources of the random access (e.g., contention-based, contention-free) procedure. The RA-SDT related RA resources are configured via RRC signaling or system information, e.g., SIBI.

A common RACH partitioning for NR features should be specified explicitly to reduce UE complexity. In other words, the preamble partitioning is defined on a feature (e.g., SDT, slicing) and/or feature combination (e.g., selected slicing, SDT or not, REDCAP or not) basis. The feature/feature combination specific parameters are configured by the network. The mapping between feature/feature combination and the associated PRACH resource set (i.e., including preambles and RACH occasion) should have an association so that once a preamble on a specific RACH occasion is received, the network can distinguish it without any ambiguity. It means that the UE can select a specific preamble from RACH partitioning in response to MT-SDT.

On the other hand, the RACH partitioning can be configured on BWPs in addition to the initial BWP so that the RA-SDT can be performed on the initial BWP or non-initial BWP (Le., active or default BWP other than the initial BWP). If the association between RA-SDT preambles and BWPs is configured, the specific preamble would be chosen for MSGA/MSG1 of 2-step/4-step RA-SDT on the specific SDT BWP.

For CG-SDT, the related resource configuration is provided to the UE in RRC CONNECTED state via the RRC signaling (e.g., RRCRelease with suspendConfig) The RSRP-based TA validation shall be applied for MT-SDT and CG-SDT procedure. When the CG-TAT is running and valid, the configured CG-SDT resources can be used for CG-SDT in response to the reception of MT-SDT. A UE-specific search space is configured for the UE(s) to perform CG-SDT procedure in response to MT-SDT. In some embodiments, the network may configure only MT-SDT without MO-SDT. The UE receives MT-SDT without UL response.

A first embodiment of the present disclosure is shown in FIG. 6, which depicts implementation scenarios of MT-SDT between the UE 10 and the base station 20 according to the present disclosure.

For supporting MT-SDT in RRC_INACTIVE, the common/UE-specific SDT configuration, SDT bearer configuration, SDT indication/resources are configured in RRC signaling (e.g., system information, RRCReconfiguration, RRCRelease with SuspendConfig. ConfiguredGrantConfig, SDTConfig). Some MT-SDT resources (e.g., semi-persistent scheduling resource, dynamic scheduling resource) are configured as the above mentioned.

In FIG. 6, a UE in RRC_INACTIVE state can be configured by the anchor gNB with an RNA. In case DL small data arrives at the UFP (User Plane Function), the core network (e.g., 5GCN) forwards the DL small data for the UE to the associated serving gNB (i.e., anchor gNB), The RAN paging for MT-SDT via Xn and radio interface is triggered when the UE is in RRC INACTIVE state. Both the anchor gNB and the cells in the same RAN create the paging with MT-SDT indication to page the UE. Upon the reception of paging with MT-SDT indication, the UB transmits RRCResumeRequest to update the RNA of UE and to request data reception in RRC_INACTIVE. Upon the reception of request from the UE the new gNB transmits the RETRIEVE UE CONTEXT REQUEST via Xn interface to acquire the VE context. In the meantime, the anchor gNB should determine whether to relocate UJE context based on the validity conditions for MT-SDT as specified above. When the anchor gNB decides to perform anchor relocation for the UE, the RETRIEVE UE CONTEXT RESPONSE including SDT bearer context is transmitted to the new gNB for UE context configuration at the new gNB side.

Upon the reception of MT-SDT indication from anchor gNB, the new gNB may decide whether to keep UE in RRC_INACTIVE state for MT-SDT based on the validity conditions for MT-SDT as specified above. When the new gNB decides to keep UE in RRC_INACTIVE, the RRCRelease message with suspendConfig. SDTConfig and/or MT-SDT indication is transmitted to the UE. The MT-SDT may transmit from the anchor gNB to the new gNB when per PDU session is set up. Path switch and UB context release are performed between the new gNB, core networks and anchor gNB. For the reception of DL small data from the anchor gNB or core network, the UE can perform Mobile Terminated (MT) small data reception procedure as the above disclosed without state transition. In addition, the UE can receive subsequent DL small data based on the MT-SDT indication and MT small data reception procedure as specified above if necessary.

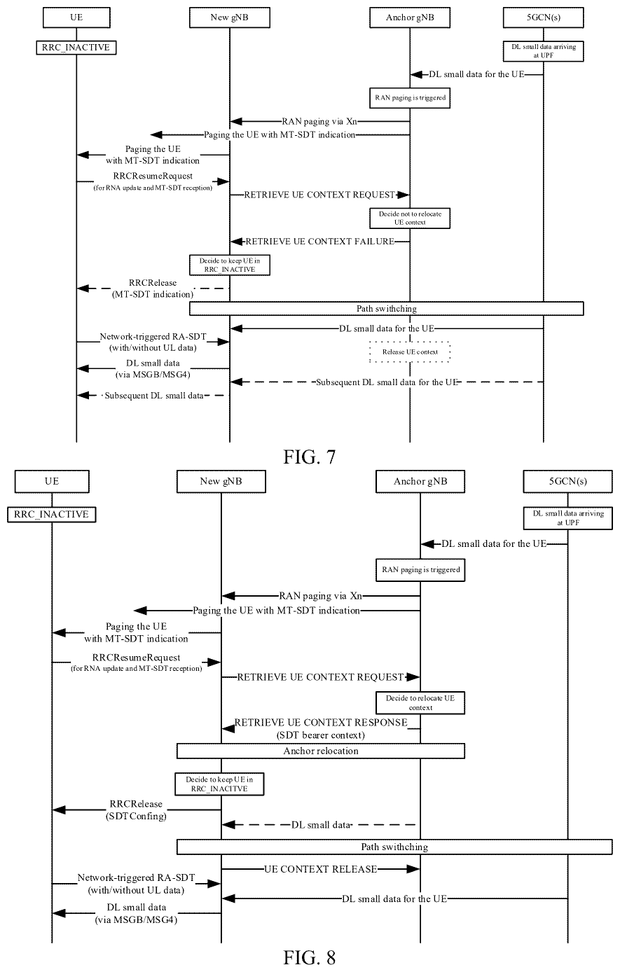

A second embodiment of the present disclosure is shown in FIG. 7, which depicts implementation scenarios of MT-SDT between the UE 10 and the base station 20 according to the present disclosure.

For supporting MT-SDT in RRC_INACTIVE, the common/UE-specific SDT configuration, SDT bearer configuration, SDT indication/resources are configured in RRC signaling (e.g., system information, RRCReconfiguration, RRCRelease with SuspendConfig, ConfiguredGrantConfig. SDTConfig), Some MT-SDT resources (e.g., semi-persistent scheduling resource, dynamic scheduling resource) are configured as the above mentioned.

In FIG. 7, a UE in RRC_INACTIVE state can be configured by the anchor gNB with an RNA In case DL small data arrives at the UFP (User Plane Function), the core network (e.g., 5GCN) forwards the DL small data for the UE to the associated serving gNB (i.e., anchor gNB). The RAN paging for MT-SDT via Xn and radio interface is triggered when the UE is in RRC INACTIVE state. Both the anchor gNB and the cells in the same RAN create the paging with MT-SDT indication to page the UE. Upon the reception of paging with MT-SDT indication, the UE transmits RRCResumeRequest to update the RNA of UE and to request data reception in RRC_INACTIVE. Upon the reception of the resume request from the UE, the new gNB transmits the RETRIEVE UE CONTEXT REQUEST via Xn interface to acquire the UE context. In the meantime, the anchor gNB should determine whether to relocate UE context based on the validity conditions for MT-SDT as specified above. When the anchor gNB decides not to perform anchor relocation for the UE, the RETRIEVE UE CONTEXT FAILURE includes an encapsulated RRCRelease.

Upon the reception of MT-SDT indication from anchor gNB, the new gNB may decide whether to keep UE in RRC INACTIVE state for MT-SDT based on the validity conditions for MT-SDT as specified above. When the new gNB decides to keep UE in RRC_INACTIVE, the RRCRelease message with suspendConfig, SDTConfig and/or MT-SDT indication is transmitted to the UE. In some cases, the MT-SDT indication is included in the paging message instead of RRCRelease message. Path switch is performed between the new gNB, core networks and anchor gNB. The anchor gNB may delete the UE context if necessary. For the reception of DL small data from the core network, the UE can perform Mobile Terminated (MT) small data reception procedure as the above disclosed without state transition.

In some cases, a network-triggered RA-SDT with/without UL small data is initiated by the UE upon the reception of MT-SDT indication and a configurable MT-SDT timer (not shown) is started. Upon the expiry of MT-SDT timer, the UE forwards a MSGA/MSG3 of network-triggered RA-SDT and receives MT-SDT on MSGB/MSG4 as well. In other words, the UE can perform Mobile Terminated (MT) small data reception procedure as the above disclosed without state transition In addition, the UE can receive subsequent DL small data based on the MT-SDT indication and MT small data reception procedure as specified above if necessary.

In some embodiments, when the new gNB decides not to keep UE in RRC INACTIVE for DL small data reception, the RRCRelease message is transmitted to the UE for moving UE in RRC_IDLE (not shown). The UE performs a legacy random-access procedure for establishing a connection and receiving DL small data with the new gNB and core network.

In some cases, the RRCResume is transmitted to the UE when the new gNB decides to move UE in RRC CONNECTED. A bearer resumption procedure following RNA update is performed for DL small data reception (not shown).

An third embodiment of the present disclosure is shown in FIG. 8, which depicts implementation scenarios of MT-SDT between the UE 10 and the base station 20 according to the present disclosure.

For supporting MT-SDT in RRC_INACTIVE, the common/UE-specific SDT configuration, SDT bearer configuration, SDT indication/resources are configured in RRC signaling (e.g., system information, RRCReconfiguration, RRCRelease with SuspendConfig, ConfiguredGrantConfig, SDTConfig). Some MT-SDT resources (e.g., semi-persistent scheduling resource, dynamic scheduling resource) are configured as the above mentioned.

In FIG. 8, a UE in RRC INACTIVE state can be configured by the anchor gNB with an RNA In case DL small data arrives at the UFP (User Plane Function), the core network (e.g., 5GCN) forwards the DL small data for the UE to the associated serving gNB (i.e., anchor gNB). The RAN paging for MT-SDT via Xn and radio interface is triggered when the UE is in RRC INACTIVE state. Both the anchor gNB and the cells in the same RAN create the paging with MT-SDT indication to page the UE. Upon the reception of paging with MT-SDT indication, the UE transmits RRCResumeRequest to update the RNA of UE and to request data reception in RRC_INACTIVE. Upon the reception of request from the UE, the new gNB transmits the RETRIEVE UE CONTEXT REQUEST via Xn interface to acquire the UE context. In the meantime, the anchor gNB should determine whether to relocate UE context based on the validity conditions for MT-SDT as specified above. When the anchor gNB decides to perform anchor relocation for the UE, the RETRIEVE UE CONTEXT RESPONSE including SDT bearer context is transmitted to the new gNB for UE context configuration at the new gNB side.

Upon the reception of MT-SDT indication from anchor gNB, the new gNB may decide whether to keep UE in RRC_INACTIVE state for MT-SDT based on the validity conditions for MT-SDT as specified above. When the new gNB decides to keep UE in RRC_INACTIVE, the RRCRelease message with suspendConfig, SDTConfig and/or MT-SDT indication is transmitted to the UE. The MT-SDT may transmit from the anchor gNB to the new gNB when per PDU session is set up. Path switch and UE context release are performed between the new gNB, core networks and anchor gNB. A network-triggered 2-step/4-step RA-SDT with/without UL small data is initiated by the UE upon the reception of MT-SDT indication and a configurable MT-SDT timer (not shown) is started. Upon the expiry of MT-SDT timer, the UE forwards a MSGA/MSG3 of network-triggered RA-SDT and receives MT-SDT on. MSGB/MSG4 as well. In other words, the UE can perform Mobile Terminated (MT) small data reception procedure as the above disclosed without state transition.

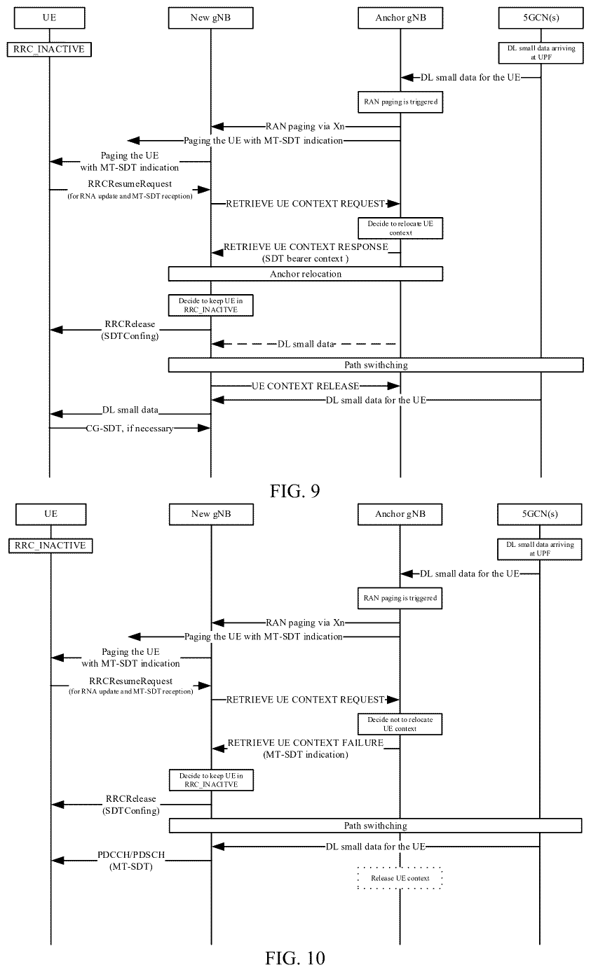

A fourth embodiment of the present disclosure is shown in FIG. 9, which depicts implementation scenarios of MT-SDT between the UE 10 and the base station 20 according to the present disclosure.

For supporting MT-SDT in RRC INACTIVE, the common/UE-specific SDT configuration, SDT bearer configuration, SDT indication/resources are configured in RRC signaling (e.g., system information, RRCReconfiguration, RRCRelease with SuspendConfig, ConfiguredGrantConfig. SDTConfig). Some MT-SDT resources (e.g., semi-persistent scheduling resource, dynamic scheduling resource) are configured as the above mentioned.

In FIG. 9, a UE in RRC_INACTIVE state can be configured by the anchor gNB with an RNA. In case DL small data arrives at the UFP (User Plane Function), the core network (e.g., 5GCN) forwards the DL small data for the UE to the associated serving gNB (Le, anchor gNB). The RAN paging for MT-SDT via Xn and radio interface is triggered when the UE is in RRC_INACTIVE state. Both the anchor gNB and the cells in the same RAN create the paging with MT-SDT indication to page the UE. Upon the reception of paging with MT-SDT indication, the UE transmits RRCResumeRequest to update the RNA of UE and to request data reception in RRC_INACTIVE. Upon the reception of request from the UE, the new gNB transmits the RETRIEVE UE CONTEXT REQUEST via Xn interface to acquire the UE context. In the meantime, the anchor gNB should determine whether to relocate UE context based on the validity conditions for MT-SDT as specified above. When the anchor gNB decides to perform anchor relocation for the UE, the RETRIEVE UE CONTEXT RESPONSE including SDT bearer context is transmitted to the new gNB for UE context configuration at the new gNB side.

Upon the reception of MT-SDT indication from anchor gNB, the new gNB may decide whether to keep UE in RRC_INACTIVE state for MT-SDT based on the validity conditions for MT-SDT as specified above. When the new gNB decides to keep UE in RRC_INACTIVE, the RRCRelease message with suspendConfig. SDTConfig and/or MT-SDT indication is transmitted to the UE. The MT-SDT may transmit from the anchor gNB to the new gNB when per PDU session is set up. Path switch and UE context release are performed between the new gNB, core networks and anchor gNB. In some cases, the MT-SDT indication and SPS activation indication are included in a paging message as well instead of RRCRelease message. SPS for MT-SDT is activated via the paging message. The UE monitors the SPS resources on the associated BWP for MT-SDT reception in RRC_INACTIVE state and performs CG-SDT as the UL response if necessary.

A fifth embodiment of the present disclosure is shown in FIG. 10, which depicts implementation scenarios of MT-SDT between the UE 10 and the base station 20 according to the present disclosure.

For supporting MT-SDT in RRC_INACTIVE, the common/UE-specific SDT configuration, SDT bearer configuration, SDT indication/resources are configured in RRC signaling (e.g., system information RRCReconfiguration, RRCRelease with SuspendConfig, ConfiguredGrantConfig, SDTConfig). Some MT-SDT resources (e.g., semi-persistent scheduling resource, dynamic scheduling resource) are configured as the above mentioned.

In FIG. 10, a UE in RRC_INACTIVE state can be configured by the anchor gNB with an RNA. In case DL small data arrives at the UFP (User Plane Function), the core network (e.g., SGCN) forwards the DL small data for the UE to the associated serving gNB (i.e., anchor gNB). The RAN paging for MT-SDT via Xn and radio interface is triggered when the UJE is in RRC INACTIVE state. Both the anchor gNB and the cells in the same RAN create the paging with MT-SDT indication to page the UE. Upon the reception of paging with MT-SDT indication, the UE transmits RRCResumeRequest to update the RNA of UJE and to request data reception in RRC_INACTIVE. Upon the reception of request from the UE, the new gNB transmits the RETRIEVE UE CONTEXT REQUEST via Xn interface to acquire the UE context. In the meantime, the anchor gNB should determine whether to relocate UE context based on the validity conditions for MT-SDT as specified above. When the anchor gNB decides not to perform anchor relocation for the UE, the RETRIEVE UE CONTEXT FAILURE including an encapsulated RRCRelease.

Upon the reception of MT-SDT indication from anchor gNB, the new gNB may decide whether to keep UE in RRC INACTIVE state for MT-SDT based on the validity conditions for MT-SDT as specified above. When the new gNB decides to keep UE in RRC INACTIVE, the RRCRelease message with suspendConfig, SDTConfig and/or MT-SDT indication is transmitted to the UB. In some cases, the MT-SDT indication and/or SPS activation is included in a paging message instead of RRCRelease message. Path switch is performed between the new gNB, core networks and anchor gNB. The anchor gNB may delete the UE context if necessary. For the reception of DL small data from the core network, the UE can perform Mobile Terminated (MT) small data reception procedure as the above disclosed without state transition. In some cases, the UE monitors the PDCCH and PDSCH on the associated BWP for MT-SDT reception in RRC_INACTIVE state.

In some embodiments, when the new gNB decides not to keep UE in RRC INACTIVE for DL small data reception, the RRCRelease message is transmitted to the UE for moving UE in RRC IDLE (not shown). The UE performs a legacy random-access procedure for establishing a connection and receiving DL data with the new gNB and core network.

In some cases, the RRCRelease with MT-SDT indication or a paging message with MT-SDT indication is transmitted to the UE. When the new gNB decides to move UE into RRC CONNECTED, a bearer resumption procedure following RNA update is performed for DL small data reception (not shown).

A sixth embodiment of the present disclosure is shown in FIG. 11, which depicts implementation scenarios of MT-SDT between the UE 10 and the base station 20 according to the present disclosure.

For supporting MT-SDT in RRC_INACTIVE, the common/UE-specific SDT configuration, SDT bearer configuration, SDT indication/resources are configured in RRC signaling (e.g., system information, RRCReconfiguration, RRCRelease with SuspendConfig, ConfiguredGrantConfig. SDTConfig). Some MT-SDT resources (e.g., semi-persistent scheduling resource, dynamic scheduling resource) are configured as the above mentioned.

In FIG. 11, a UB in RRC_INACTIVE state can be configured by the anchor eNB with an RNA. In case the RRC INACTIVE UE moves out of the configured RNA it is required to initiate the RNA update procedure via RRCResumeRequest In some cases, the RNA update procedure is triggered by a configured periodic RNA Update timer. Upon the reception of RNA update from the UE, the new gNB transmits the RETRIEVE UE CONTEXT REQUEST via Xn interface to acquire the UE context In the meantime, if DL small data for the UE is arriving in anchor gNB's buffer from core networks (e.g., 5GCN), the anchor QNB should determine whether to relocate UE context based on the validity conditions for MT-SDT as specified above. When the anchor gNB decides to perform anchor relocation for the UE, the RETRIEVE UE CONTEXT RESPONSE including SDT bearer context and MT-SDT indication is transmitted to the new gNB for UE context configuration at the new gNB side.

Upon the reception of MT-SDT indication from the anchor gNB, the new gNB may decide whether to keep UE in RRC_INACTIVE state for MT-SDT based on the validity conditions for MT-SDT as specified above. When the new gNB decides to keep UE in RRC INACTIVE, the RRCRelease message with suspendConfig. SDTConfig and MT-SDT indication is transmitted to the UE. The MT-SDT may transmit from the anchor gNB to the new gNB when per PDU session is set up. Path switch and UE context release are performed between the new gNB, core networks and anchor gNB. For the reception of DL small data from the anchor gNB or core network, the UE can perform Mobile Terminated (MT) small data reception procedure as the above disclosed without state transition. In addition, the UE can receive subsequent DL small data based on the MT-SDT indication and MT small data reception procedure as specified above if necessary.

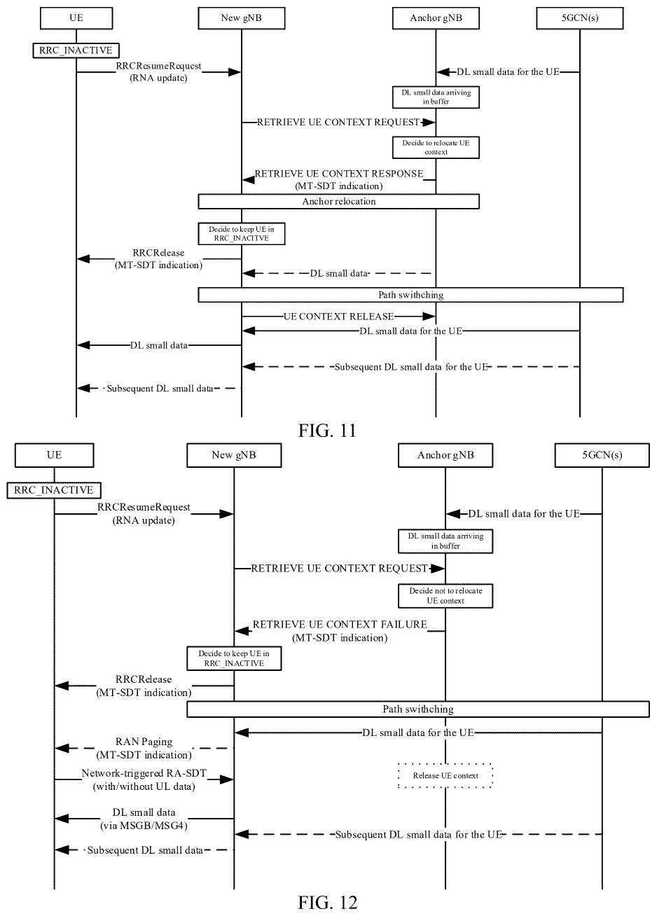

A seventh embodiment of the present disclosure is shown in FIG. 12, which depicts implementation scenarios of MT-SDT between the UE 10 and the base station 20 according to the present disclosure.

For supporting MT-SDT in RRC_INACTIVE, the common/UE-specific SDT configuration, SDT bearer configuration, SDT indication/resources are configured in RRC signaling (e.g., system information, RRCReconfiguration, RRCRelease with SuspendConfig, ConfiguredGrantConfig. SDTConfig). Some MT-SDT resources (e.g., semi-persistent scheduling resource, dynamic scheduling resource) are configured as the above mentioned.

In FIG. 12, a UE in RRC INACTIVE state can be configured by the anchor gNB with an RNA. In case the RRC INACTIVE UE moves out of the configured RNA it is required to initiate the R. NA update procedure via RRCResumeRequest. In some cases, the RNA update procedure is triggered by a configured periodic RNA Update timer. Upon the reception of RNA update from the UB, the new gNB transmits the RETRIEVE UE CONTEXT REQUEST via Xn interface to acquire the UE context. In the meantime, if DL small data for the UE is arriving in anchor gNB's buffer from core networks (e.g., SGCN), the anchor gNB should determine whether to relocate UE context based on the validity conditions for MT-SDT as specified above. When the anchor gNB decides not to perform anchor relocation for the UE, the RETRIEVE UE CONTEXT FAILURE including an encapsulated RRCRelease. The RRCRelease includes at least MT-SDT indication for the UE.

Upon the reception of MT-SDT indication from anchor gNB, the new gNB may decide whether to keep UE in KRC_INACTIVE state for MT-SDT based on the validity conditions for MT-SDT as specified above. When the new gNB decides to keep UE in RRC INACTIVE, the RRCRelease message with suspendConfig, SDTConfig and/or MT-SDT indication is transmitted to the UE. In some cases, the MT-SDT indication is included in a paging message instead of RRCRelease message. Path switch is performed between the new gNB, core networks and anchor gNB. The anchor NB may delete the UE context if necessary. For the reception of DL small data from the core network, the UE can perform Mobile Terminated (MT) small data reception procedure as the above disclosed without state transition.

In some cases, a network-triggered RA-SDT with/without UL small data is initiated by the UE upon the reception of MT-SDT indication and a configurable MT-SDT timer (not shown) is started Upon the expiry of MT-SDT timer, the UE forwards a MSGA/MSG3 of network-triggered RA-SDT and receives MT-SDT on MSGB/MSG4 as well. In other words, the UE can perform Mobile Terminated (MT) small data reception procedure as the above disclosed without state transition. In addition, the UE can receive subsequent DL small data based on the MT-SDT indication and MT small data reception procedure as specified above if necessary.

In some embodiments, when the new gNB decides not to keep UE in RRC INACTIVE for DL small data reception, the RRCRelease message is transmitted to the UE for moving UE in RRC IDLE (not shown). The UE performs a legacy random-access procedure for establishing a connection and receiving DL small data with the new gNB and core network.

In some cases, the RRCResume with MT-SDT indication or a paging message with MT-SDT indication is transmitted to the UE when the new gNB decides to move UE in RRC CONNECTED. A bearer resumption procedure following RNA update is performed for DL small data reception (not shown).

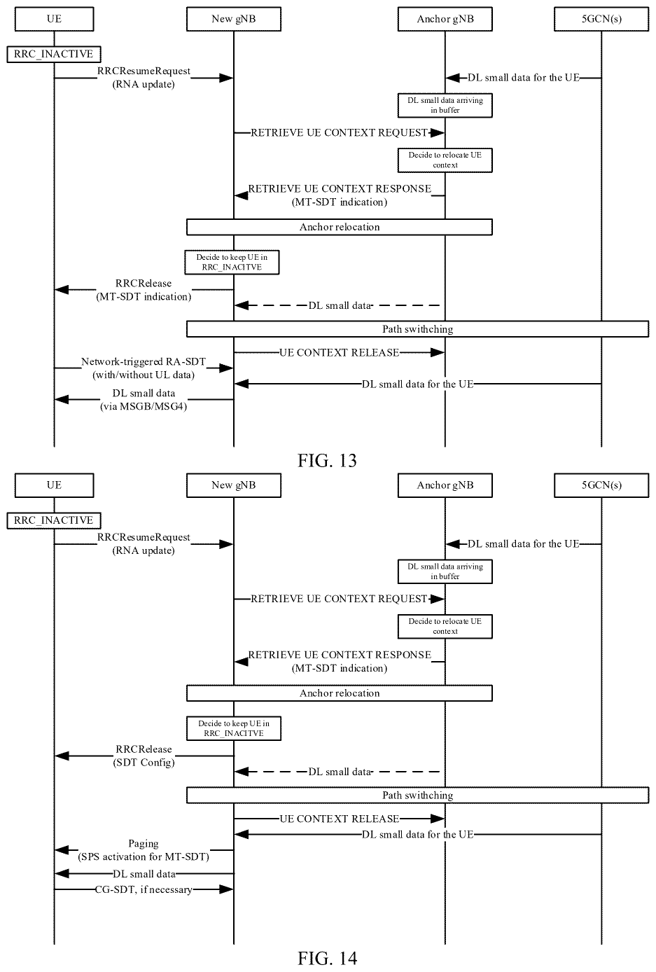

An eighth embodiment of the present disclosure is shown in FIG. 13, which depicts implementation scenarios of MT-SDT between the UE 10 and the base station 20 according to the present disclosure.

For supporting MT-SDT in RRC_INACTIVE, the common/UE-specific SDT configuration, SDT bearer configuration, SDT indication/resources are configured in RRC signaling (e.g., system information, RRCReconfiguration. RRCRelease with SuspendConfig, ConfiguredGrantConfig. SDTConfig). Some MT-SDT resources (e.g., semi-persistent scheduling resource, dynamic scheduling resource) are configured as the above mentioned.

In FIG. 13, a UE in RRC INACTIVE state can be configured by the anchor gNB with an RNA. In case the RRC INACTIVE UE moves out of the configured RNA it is required to initiate the RNA update procedure via RRCResumeRequest. In some cases, the RNA update procedure is triggered by a configured periodic RNA Update timer. Upon the reception of RNA update from the UB, the new gNB transmits the RETRIEVE UE CONTEXT REQUEST via Xn interface to acquire the UE context. In the meantime, if DL small data for the UE is arriving in anchor gNB's buffer from core networks (e.g., 5GCN), the anchor gNB should determine whether to relocate UE context based on the validity conditions for MT-SDT as specified above. When the anchor gNB decides to perform anchor relocation for the UE, the RETRIEVE UE CONTEXT RESPONSE including SDT bearer context and MT-SDT indication is transmitted to the new gNB for UE context configuration at the new gNB side.

Upon the reception of MT-SDT indication from anchor gNB, the new gNB may decide whether to keep UE in KRC_INACTIVE state for MT-SDT based on the validity conditions for MT-SDT as specified above. When the new gNB decides to keep UE in RRC_INACTIVE, the RRCRelease message with suspendConfig, SDTConfig and MT-SDT indication is transmitted to the UE. The MT-SDT may transmit from the anchor gNB to the new gNB when per PDU session is set up. Path switch and UE context release are performed between the new gNB, core networks and anchor gNB. A network-triggered 2-step/4-step RA-SDT with/without UL small data is initiated by the UE upon the reception of MT-SDT indication and a configurable MT-SDT timer (not shown) is started. Upon the expiry of MT-SDT timer, the UE forwards a MSGA/MSG3 of network-triggered RA-SDT and receives MT-SDT on MSGB/MSG4 as well. In other words, the UE can perform Mobile Terminated (MT) small data reception procedure as the above disclosed without state transition.

A nineth embodiment of the present disclosure is shown in FIG. 14, which depicts implementation scenarios of MT-SDT between the UE 10 and the base station 20 according to the present disclosure.

For supporting MT-SDT in RRC_INACTIVE, the common/UE-specific SDT configuration, SDT bearer configuration, SDT indication/resources are configured in RRC signaling (e.g., system information, RRCReconfiguration, RRCRelease with SuspendConfig. ConfiguredGrantConfig. SDTConfig). Some MT-SDT resources (e.g., semi-persistent scheduling resource, dynamic scheduling resource) are configured as the above mentioned.

In FIG. 14, a UE in RRC_INACTIVE state can be configured by the anchor gNB with an RNA. In case the RRC INACTIVE UE moves out of the configured RNA it is required to initiate the RNA update procedure via RRCResumeRequest. In some cases, the RNA update procedure is triggered by a configured periodic RNA Update timer. Upon the reception of RNA update from the UE, the new gNB transmits the RETRIEVE UE CONTEXT REQUEST via Xn interface to acquire the UB context. In the meantime, if DL small data for the UE is arriving in anchor gNB's buffer from core networks (e.g., SGCN), the anchor gNB should determine whether to relocate UE context based on the validity conditions for MT-SDT as specified above. When the anchor gNB decides to perform anchor relocation for the UE, the RETRIEVE UE CONTEXT RESPONSE including SDT bearer context and MT-SDT indication is transmitted to the new @NB for UE context configuration at the new gNB side.

Upon the reception of MT-SDT indication from anchor gNB, the new gNB may decide whether to keep UE in RRC_INACTIVE state for MT-SDT based on the validity conditions for MT-SDT as specified above. When the new gNB decides to keep UE in RRC INACTIVE, the RRCRelease message with suspendConfig, SDTConfig, and MT-SDT indication are transmitted to the UE. The MT-SDT may transmit from the anchor gNB to the new gNB when per PDU session is set up. Path switch and UE context release are performed between the new gNB, core networks and anchor gNB. In some cases, the MT-SDT indication or SPS activation indication is included in the paging message instead of RRCRelease message. SPS for MT-SDT is activated via the paging message. The UE monitors the SPS resources on the associated BWP for MT-SDT reception in RRC_INACTIVE state and performs CG-SDT as the UL response if necessary.

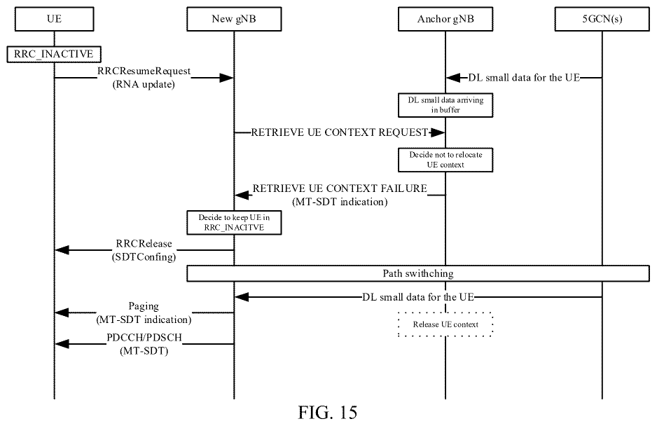

A tenth embodiment of the present disclosure is shown in FIG. 15, which depicts implementation scenarios of MT-SDT between the UE 10 and the base station 20 according to the present disclosure.

For supporting MT-SDT in RRC_INACTIVE, the common/UE-specific SDT configuration, SDT bearer configuration, SDT indication/resources are configured in RRC signaling (e.g., system information, RRCReconfiguration, RRCRelease with SuspendConfig, ConfiguredGrantConfig, SDTConfig). Some MT-SDT resources (e.g., semi-persistent scheduling resource, dynamic scheduling resource) are configured as the above mentioned.

In FIG. 15, a UE in RRC_INACTIVE state can be configured by the anchor gNB with an RNA. In case the RRC_INACTIVE UE moves out of the configured RNA it is required to initiate the RNA update procedure via RRCResumeRequest In some cases, the RNA update procedure is triggered by a configured periodic RNA Update timer. Upon the reception of RNA update from the UE, the new gNB transmits the RETRIEVE UE CONTEXT REQUEST via Xn interface to acquire the UE context In the meantime, if DL small data for the UE is arriving in anchor gNB's buffer from core networks (e.g., 5GCN), the anchor gNB should determine whether to relocate UE context based on the validity conditions for MT-SDT as specified above. When the anchor gNB decides not to perform anchor relocation for the UE, the RETRIEVE UE CONTEXT FAILURE includes an encapsulated RRCRelease. Upon the reception of MT-SDT indication from anchor gNB, the new gNB may decide whether to keep UE in RRC INACTIVE state for MT-SDT based on the validity conditions for MT-SDT as specified above. When the new gNB decides to keep UE in RRC_INACTIVE, the RRCRelease message with suspendConfig, SDTConfig and/or MT-SDT indication is transmitted to the UE. In some cases, the MT-SDT indication is included in a paging message instead of RRCRelease message. Path switch is performed between the new gNB, core networks and anchor gNB. The anchor gNB may delete the UE context if necessary. For the reception of DL small data from the core network, the UE can perform Mobile Terminated (MT) small data reception procedure as the above disclosed without state transition. In some cases, the UE monitors the PDCCH and PDSCH on the associated BWP for MT-SDT reception in RRC INACTIVE state.

In some embodiments, when the new gNB decides not to keep UE in RRC INACTIVE for DL small data reception, the RRCRelease message is transmitted to the UE for moving UE in RRC IDLE (not shown). The UE performs a legacy random-access procedure for establishing a connection and receiving DL data with the new gNB and core network.

In some cases, either the RRCRelease with MT-SDT indication or a paging message with MT-SDT indication is transmitted to the UJE when the new gNB decides to move UJE into RRC_CONNECTED. A bearer resumption procedure following RNA update is performed for DL small data reception (not shown).

In accordance with another aspect of the present disclosure, UE data connection is maintained as long as UB associated FI AP messages need to be exchanged over the FI interface. Based on the aforesaid embodiments, if the network is a RAN functional split node(s), the UL/DL SDT can be transparent between Central Unit (CU) and Distributed Unit(s) (DU(s)) via FI interface and signaling.

In accordance with another aspect of the present disclosure, when MT-SDT in RRC INACTIVE state is considered on Bandwidth Part (BWP) adaptation, the network is configured with one or multiple BWPs. There is one or more specific BWPs (e.g., initial, default, activated BWP(s) configured to transmit SDT in RRC INACTIVE state, The BWP switching for the MT-SDT with random-access procedure is used while transmitting SDT in RRC INACTIVE or RRC_CONNECTED state. The UL/DL small data can be transmitted on the associated BWP according to the same UL/DL BWP bwp-Identifier/linkage.

Commercial interests for some embodiments are as follows. 1. solving issues in the prior art. 2. better resource efficiency for cellular networks. 3 realizing mobile terminated (MT) traffic transmission in the power saving state. 4. improving power consumption and signaling overhead. 5. providing a good communication performance. Some embodiments of the present disclosure are used by 5G-NR chipset vendors, V2X communication system development vendors, automakers including cars, trains, trucks, buses, bicycles, moto-bikes, helmets, and etc., drones (unmanned aerial vehicles), smartphone makers, communication devices for public safety use, AR/VR device maker for example gaming, conference/seminar, education purposes. Some embodiments of the present disclosure are a combination of “techniques/processes” that can be adopted in 3GPP specification to create an end product. Some embodiments of the present disclosure could be adopted in the 5G NR unlicensed band communications. Some embodiments of the present disclosure propose technical mechanisms.

The embodiment of the present application further provides a computer readable storage medium for storing a computer program. The computer readable storage medium enables a computer to execute corresponding processes implemented by the UE/BS in each of the methods of the embodiment of the present disclosure. For brevity, details will not be described herein again.

The embodiment of the present application further provides a computer program product including computer program instructions. The computer program product enables a computer to execute corresponding processes implemented by the UE/BS in each of the methods of the embodiment of the present disclosure. For brevity, details will not be described herein again.

The embodiment of the present application further provides a computer program. The computer program enables a computer to execute corresponding processes implemented by the UE/BS in each of the methods of the embodiment of the present disclosure. For brevity, details will not be described herein again.

Although not shown in detail any of the devices or apparatus that form part of the network may include at least a processor, a storage unit and a communications interface, wherein the processor unit, storage unit, and communications interface are configured to perform the method of any aspect of the present invention Further options and choices are described below.

The signal processing functionality of the embodiments of the invention especially the gNB and the UE may be achieved using computing systems or architectures known to those who are skilled in the relevant art. Computing systems such as, a desktop, laptop or notebook computer, hand-held computing device (PDA, cell phone, palmtop, etc.) , mainframe, server, client, or any other type of special or general purpose computing device as may be desirable or appropriate for a given application or environment can be used. The computing system can include one or more processors which can be implemented using a general or special-purpose processing engine such as, for example, a microprocessor, microcontroller or other control module.

The computing system can also include a main memory, such as random access memory (RAM) or other dynamic memory, for storing information and instructions to be executed by a processor. Such a main memory also may be used for storing temporary variables or other intermediate information during execution of instructions to be executed by the processor. The computing system may likewise include a read only memory (ROM) or other static storage device for storing static information and instructions for a processor.

The computing system may also include an information storage system which may include, for example, a media drive and a removable storage interface. The media drive may include a drive or other mechanism to support fixed or removable storage media, such as a hard disk drive, a floppy disk drive, a magnetic tape drive, an optical disk drive, a compact disc (CD) or digital video drive (DVD) read or write drive (R or RW), or other removable or fixed media drive. Storage media may include, for example, a hard disk, floppy disk, magnetic tape, optical disk, CD or DVD, or other fixed or removable medium that is read by and written to by media drive. The storage media may include a computer-readable storage medium having particular computer software or data stored therein.

In alternative embodiments, an information storage system may include other similar components for allowing computer programs or other instructions or data to be loaded into the computing system. Such components may include, for example, a removable storage unit and an interface, such as a program cartridge and cartridge interface, a removable memory (for example, a flash memory or other removable memory module) and memory slot, and other removable storage units and interfaces that allow software and data to be transferred from the removable storage unit to computing system.

The computing system can also include a communications interface. Such a communications interface can be used to allow software and data to be transferred between a computing system and external devices. Examples of communications interfaces can include a modem, a network interface (such as an Ethernet or other NIC card), a communications port (such as for example, a universal serial bus (USB) port), a PCMCIA slot and card, etc. Software and data transferred via a communications interface are in the form of signals which can be electronic, electromagnetic, and optical or other signals capable of being received by a communications interface medium.

In this document, the terms ‘computer program product’, ‘computer-readable medium’ and the like may be used generally to refer to tangible media such as, for example, a memory, storage device, or storage unit. These and other forms of computer-readable media may store one or more instructions for use by the processor including the computer system to cause the processor to perform specified operations. Such instructions, generally referred to as ‘computer program code’ (which may be grouped in the form of computer programs or other groupings), when executed, enable the computing system to perform functions of embodiments of the present invention. Note that the code may directly cause a processor to perform specified operations, be compiled to do so, and/or be combined with other software, hardware, and/or firmware elements (e.g., libraries for performing standard functions) to do so.

The non-transitory computer readable medium may include at least one from a group consisting of a hard disk, a CD-ROM, an optical storage device, a magnetic storage device, a Read Only Memory, a Programmable Read Only Memory, an Erasable Programmable Read Only Memory, EPROM, an Electrically Erasable Programmable Read Only Memory and a Flash memory. In an embodiment where the elements are implemented using software, the software may be stored in a computer-readable medium and loaded into computing system using, for example, removable storage drive. A control module (in this example, software instructions or executable computer program code), when executed by the processor in the computer system, causes a processor to perform the functions of the invention as described herein.

Furthermore, the inventive concept can be applied to any circuit for performing signal processing functionality within a network element. It is further envisaged that for example, a semiconductor manufacturer may employ the inventive concept in a design of a stand-alone device, such as a microcontroller of a digital signal processor (DSP), or application-specific integrated circuit (ASIC) and/or any other sub-system element.

It will be appreciated that, for clarity purposes, the above description has described embodiments of the invention with reference to a single processing logic. However, the inventive concept may equally be implemented by way of a plurality of different functional units and processors to provide the signal processing functionality. Thus, references to specific functional units are only to be seen as references to suitable means for providing the described functionality, rather than indicative of a strict logical or physical structure or organization.

Aspects of the invention may be implemented in any suitable form including hardware, software, firmware or any combination of these. The invention may optionally be implemented, at least partly, as computer software running on one or more data processors and/or digital signal processors or configurable module components such as FPGA devices.

Thus, the elements and components of an embodiment of the invention may be physically, functionally and logically implemented in any suitable way. Indeed, the functionality may be implemented in a single unit, in a plurality of units or as part of other functional units. Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term ‘comprising’ does not exclude the presence of other elements or steps.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather indicates that the feature is equally applicable to other claim categories, as appropriate.

Furthermore, the order of features in the claims does not imply any specific order in which the features must be performed and in particular the order of individual steps in a method claim does not imply that the steps must be performed in this order. Rather, the steps may be performed in any suitable order. In addition, singular references do not exclude a plurality. Thus, references to ‘a’, ‘an’, ‘first’, ‘second’, etc. do not preclude a plurality.

While the present application has been described in connection with what is considered the most practical and preferred embodiments, it is understood that the present application is not limited to the disclosed embodiments but is intended to cover various arrangements made without departing from the scope of the broadest interpretation of the appended claims.

1-68. (canceled)

69. A method for small data transmission (SDT) in a power saving state, performed by a user equipment (UE) in a network, the method comprising:
being configured with radio bearers for small data transmission (SDT);
monitoring a mobile terminated (MT)-SDT indication in a paging occasion in the power saving state;
upon reception of the MT-SDT indication via radio access network (RAN) paging, transmitting a connection resume request with a resume cause indicating mobile terminated small data transmission (MT-SDT) to request data reception in the power saving state; and
in response to the request of data reception being accepted, performing the MT-SDT to receive data based on the configured radio bearers without state transition.

70. The method of claim 69, wherein the MT-SDT is transmitted on MT-SDT resources and allocation for the MT-SDT resources is associated with a configured configuration, and in response to reception of the data via the MT-SDT, a response is transmitted on configured grant (CG)-SDT resources.

71. The method of claim 69, wherein due to UE mobility, the radio bearers for SDT are configured in a SDT bearer configuration, which is from an anchor base station which the UE anchors at.

72. The method of claim 71, wherein the SDT bearer configuration is stored in UE context.

73. The method of claim 69, wherein due to UE mobility, the radio bearers for SDT are configured in a SDT bearer configuration, which is from a non-anchor base station, and the SDT bearer configuration is included in UE context, which is retrieved from an anchor base station.

74. The method of claim 69, wherein the connection resume request is transmitted to update a RAN notification area (RNA) of the UE, and a bearer resumption procedure following the RNA update is performed for downlink (DL) small data reception while keeping in the power saving state.

75. The method of claim 69, wherein the MT-SDT indication is received via a paging message from an anchor base station which the UE anchors at or from a non-anchor base station which the UE is to connect with.

76. The method of claim 69, wherein the MT-SDT is transmitted on MT-SDT resources following the transmission of MT-SDT indication, and semi-persistent scheduling (SPS) for the MT-SDT is activated via the same paging message carrying the MT-SDT indication.

77. The method of claim 69, wherein the transmission of MT-SDT follows a paging occasion based on a MT-SDT interval/offset.

78. The method of claim 69, wherein the transmission of MT-SDT is scheduled before a CG occasion based on a CG-SDT interval/offset.

79. The method of claim 69, wherein the MT-SDT is performed on MT-SDT resources, which are used only when at least one of the following validity conditions for MT-SDT is met:
DL small data payload is allowed for MT-SDT resources;
QoS constraints is allowed for MT-SDT;
SDT bearer configuration is done for the UE with/without anchor relocation;
Periodic RNA Update timer is valid;
RAN paging is successful.

80. The method of claim 69, wherein the MT-SDT is performed based on a random access (RA)-SDT, which is based on a random access procedure, with or without uplink (UL) small data, and the RA-SDT is initiated by the UE upon reception of the MT-SDT indication.

81. The method of claim 80, wherein in response to the MT-SDT, a specific preamble for the random access procedure is selected from a preamble partitioning.

82. The method of claim 69, further comprising:
resuming connection to fallback to a connected state for non-SDT data reception upon non-SDT downlink (DL) data arrival during a SDT session.

83. A method for small data transmission (SDT) in a power saving state, performed by a user equipment (UE) in a network, the method comprising:
being configured with radio bearers for small data transmission (SDT);
transmitting a connection resume request with a resume cause indicating mobile terminated small data transmission (MT-SDT) to request data reception in the power saving state; and
in response to the request of data reception being accepted, upon reception of a mobile terminated (MT)-SDT indication, performing the MT-SDT to receive data based on the configured radio bearers without state transition.

84. A method for small data transmission (SDT), performed by a base station (BS) in a network, the method comprising:
configuring a user equipment (UE) with radio bearers for small data transmission (SDT);
transmitting a mobile terminated (MT)-SDT indication in a paging occasion for the UE in a power saving state;
expecting to receive a connection resume request with a resume cause indicating mobile terminated small data transmission (MT-SDT) to request data reception in the power saving state if the UE receives the MT-SDT indication via radio access network (RAN) paging; and
transmitting the MT-SDT based on the configured radio bearers if the request of data reception is accepted, for the UE to receive data without state transition.

85. The method of claim 84, wherein the base station receives the MT-SDT indication via the RAN paging and transmits the MT-SDT indication to the UE in a paging message in the paging occasion, and the MT-SDT indication included in the RAN paging comprises one bit used to indicate the UE that there are downlink (DL) small data for the UE in the power saving state.

86. The method of claim 85, wherein the MT indication included in the RAN paging further comprises additional bits associated with resource allocation of allowed DL small data payload for the UE in the power saving state.

87. A user equipment (UE), comprising a memory and a processor coupled to the memory, the processor configured to call and run program instructions stored in a memory to execute the method of claim 69.

88. A base station (BS), comprising a memory and a processor coupled to the memory, the processor configured to call and run program instructions stored in a memory to execute the method of claim 84.
